(19) United States
(12) Patent Application Publication
(10) Pub. No.: US 2020/0060104 A1
(43) Pub. Date: Feb. 27, 2020

(54) APPARATUS AND METHOD FOR A TELESCOPIC TREE SUPPORT

(71) Applicant: Noel Jarrett, Bridgeport, CT (US)

(72) Inventor: Noel Jarrett, Bridgeport, CT (US)

(21) Appl. No.: 16/109,105

(22) Filed: Aug. 22, 2018

(51) Int. Cl. A01G 17/10; F16B 7/10

(52) U.S. Cl. CPC A01G 17/10; F16B 7/105

(57) ABSTRACT

An adjustable tree limb support is presented. The tree limb support has a pole. The pole two portions, the portion connected using a connector to secure the limb support. The bottom portion of the limb support has at least one leg and is generally desired to be a tri-pod for safety. The connectors for the two poles can be integrated within the poles, such as a series of holes in one portion and an extendable connector in the other portion that engages within one of the holes.

### FIELD OF THE INVENTION

The present invention relates generally to tree supports, and particularly to a telescopic tree support.

### BACKGROUND

As trees age, oftentimes, their branches become less healthy and vigorous and, without suitable intervention, oftentimes would break away from the main trunk of the tree. This can also occur with healthy branches that may be unduly stressed by weight. For example, as fruit develops on the branches of a fruit bearing tree stress is created that the branch or limb must support.

There are many reasons why one may wish to save a tree limb under distress rather than to simply remove it from the main trunk system. If the limb is fruit bearing, the distress would be removed once the fruit is harvested. Even in situations where a limb is less than vigorous, it is oftentimes desirable to save it rather than to prune or remove it. For example, such a limb could aesthetically add to the visual appearance of a tree or provide shade or privacy which the tree owner would wish to maintain if possible.

Several prior techniques have been employed in attempts to save distressed limbs. It is not uncommon to see braided wire fixed between the limb and load bearing trunk portions of the tree which, although are functional, further provide distress as such braided wire is generally screwed into the bark and limb of the trunk. Further, such guide wires are often unsightly and prove to be aesthetically detracting from the tree's overall appearance in many instances.

It is also oftentimes desirable to provide a limb support system on a temporary basis only to be removed once distress is no longer placed upon the limb. For example, when the tree is fruit bearing, once the fruit is harvested, there is oftentimes not a need to continue supporting the limb, at least until fruit reemerges in the following growing season.

What is needed is to provide a device capable of supporting a limb of a tree, and to provide a device for supporting a limb without involving the trunk or bark portion of the tree and without fixing the support device permanently proximate the distressed limb.

Yet another need is to provide a limb supporting device capable of being adjustable in height and capable of residing upon uneven terrain to enable the device to function appropriately proximate a distressed limb regardless of surrounding conditions.

### BRIEF DESCRIPTION OF THE DRAWINGS

FIG. 1 is an exemplary tree support apparatus.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

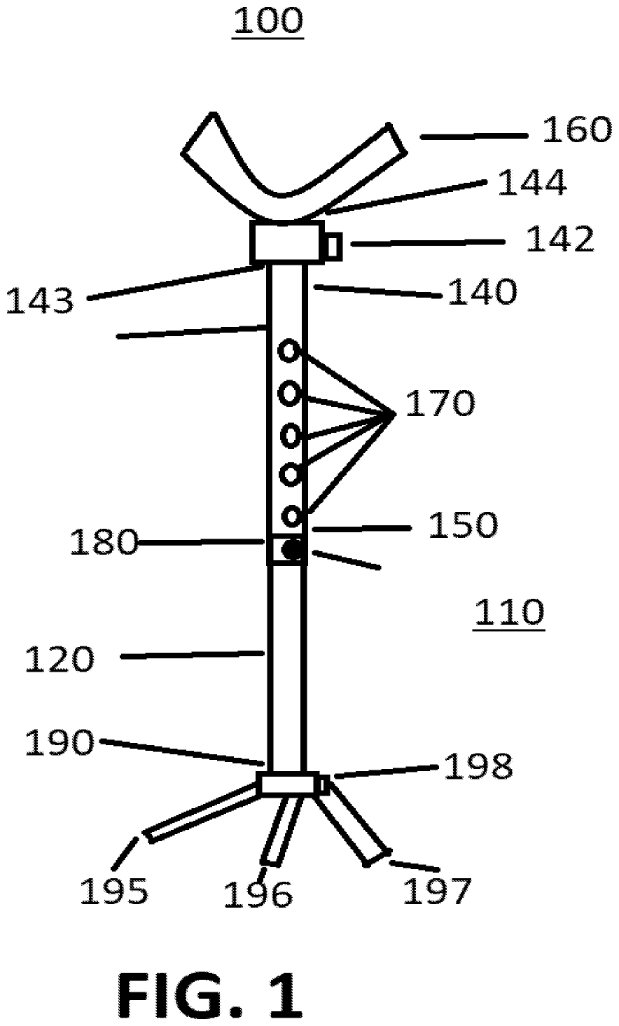

Referring now to FIG. 1, a tree limb support apparatus is presented. The tree support apparatus 100 is useful in supporting tree limbs under various conditions. The tree limb may have broken and is necessary to support to properly remove it from the tree. The tree limb may be overweight and a limb support would allow a person to remove branches from the tree limb to reduce the bulk of the tree limb.

The tree limb support 100 has a pole 110. The pole is generally straight and made of a material which is strong and ecologically friendly. The material may be polyvinyl chloride (PVC), wood, heavy plastic, etc.

The pole 110 is adjustable and has a first portion 120 and a second portion 130. The first portion 120 has a proximal end 140 and a distal end 150. The proximal end 140 of the first portion is generally attachable to a support fork 160.

The first portion 120 of the pole 110 may have one or more holes 170. The one or more holes 170 may be any size and any shape that is conducive to providing a secure pole 110. The one or more holes 170 may form a straight line or may be off centered through the first portion 120 of the pole 110.

The second portion 130 of the pole 110 has a proximal end 180 and a distal end 190. The proximal end 180 of the second portion 130 of the pole 110 has a connector below the end of the proximal end 180 of the second portion 130 of the pole 110. The connector 192 may be any size or shape but must be compatible with the one or more holes 170 of the first portion 120 of the pole 110. The connector 192 must fit securely into the one or more holes 180 of the first portion 120 of the pole 110.

To create the entire pole 110, the proximal end 180 of the second portion 130 of the pole 110 is slid into the distal end 150 of the first portion 120 of the pole 110. The determination of how long to make the pole 110 is made by measuring the distance from where the tree limb needs to be relative to the ground. The measurement is used to then slide the proximal end 180 of the second portion 130 of the pole 110 into the distal end 150 of the first portion 120 of the pole 110 until the desired length is reached. The connector 192 of the second portion 130 of the pole 110 is then released into one of the one or more holes 170 at the desired or substantially near the desired length. Once the connector 192 of the second portion 130 of the pole 110 is set in the one of the one or more holes 170 of the first portion 120 of the pole, the pole 110 is secure.

At the proximate end 140 of the first portion 120 of the pole 110 is a fork connection 142. The fork connection is coupled to the proximate end 140 of the pole 110 on a first side 143 and to the support fork 160 on a second side 144. The fork connector 142 may have any kind or type of connector that would securely couple the fork support 160 to the proximal end 140 of the first portion 120 of the pipe 110.

The distal end 190 of the second portion 130 of the pipe 110 is coupled to a support leg 194. The support leg 194 may be any secure structure, such as a trip-pod, a round base, etc. The FIG. 1 has a three-legged support leg 194. The three legs 195, 196, 197 are joined at a base 198. The base 198 of the support leg 194 is securely coupled 198 to the distal end 190 of the second portion 130 of the pipe 110 such that when the tree limb support 100 is placed to support the limb that a secure and stable condition is created to protect the user.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A tree limb support, the tree limb support comprising:
a pole, the pole having a first portion and a second portion;
the first portion of the pole having a distal end and a proximate end;
the distal end of the first portion of the pole coupled to a support fork;
the second portion of the pole having a proximate end, the proximate end of the second portion of the pole being coupled to at least one legs;
the distal end of the first portion of the pole being coupled to the proximate end of the second portion of the pole; and
the pole having connectors to securely couple the first portion to the second portion.

2. The tree limb support of claim 1, wherein the one or more legs comprise a tripod.

3. The tree limb support of claim 1, wherein the proximate end of the second portion of the pole is coupled to the distal end of the first portion, wherein the second portion has an extended button and the second portion has at least one hole and wherein the extended button of the second portion engages into one of the at least one hole of the first portion.

4. The tree limb support of claim 1, further comprising an external connector, wherein the proximate end of the second portion of the pole is coupled to the distal end of the first portion wherein the first portion and the second portion having at least one hole and wherein the external connector is engaged thru one of the at least one hole of the first portion and one of the at least one hole of the second portion.

5. The tree limb support of claim 1, wherein the support fork is U shaped.

6. The tree limb support of claim 1, wherein the pole is aluminum.

7. A method for supporting a tree limb, comprising:
determining a tree limb to support;
coupling a first portion of a pole to a second portion of the pole, wherein the distance is calculated from the desired height of the tree limb to the ground;
engaging the support fork to a distal end of the first portion;
sliding the tree support under the limb, engaging the support fork with the tree limb; and
securing a distal portion of the pole to the ground.

8. The method of claim 7 wherein the distal end of the second portion being coupled to at least one leg.

9. The method of claim 8 wherein the at least one leg forms a tri-pod.

10. The method of claim 7 wherein support fork is U shaped.
